(19) United States
(12) Patent Application Publication
(10) Pub. No.: US 2014/0199453 A1
(43) Pub. Date: Jul. 17, 2014

(54) METHOD AND SYSTEM FOR PROCESSING USED COOKING OIL

(71) Applicant: Jeff T. Deweese, Saratoga Springs, NY (US)

(72) Inventor: Jeff T. Deweese, Saratoga Springs, NY (US)

(73) Assignee: UNITY FUELS LLC, Newark, NJ (US)

(21) Appl. No.: 14/122,278

(22) PCT Filed: May 29, 2012
(86) PCT No.: PCT/US2012/039861

§ 371 Date: Mar. 12, 2014

Related U.S. Application Data
(60) Provisional application No. 61/490,433, filed on May 26, 2011.

(51) Int. Cl. A23D 9/04; A47J 37/12

(52) U.S. Cl. CPC A23D 9/04; A47J 37/1223
USPC 426/495; 210/167.28

(57) ABSTRACT

Methods and systems for processing used cooking oil to remove contaminates therefrom to produce recycled cooking oil are disclosed. The systems and methods may comprise a continuous flow of the used cooking oil therethrough. The methods and systems may comprise a first filter configured to remove solid contaminates of a first size from used cooking oil flowing therethrough, and a heating mechanism in communication with the first filter to heat the used cooking oil to at least about 120 degrees Fahrenheit. The methods and systems may further comprise a centrifuge mechanism in communication with the heating mechanism to remove solid contaminates and liquid contaminates from the heated used cooing oil. The methods and systems may also comprise a second filter in communication with the centrifuge mechanism that is configured to remove solid contaminates of a second size from the used cooking oil to produce processed recycled cooking oil.

### CROSS REFERENCE TO RELATED APPLICATION

This patent application claims the benefit of U.S. Provisional Patent Application No. 61/490,433 filed on May 26, 2011, the disclosure of which is included by reference herein in its entirety.

### FIELD OF THE INVENTION

The present invention relates to the field of producing feedstock for biodiesel, and, in particular, to systems, methods and devices for processing used cooking oil into feedstock for biodiesel.

### BACKGROUND INFORMATION

In order to implement used cooking oil (UCO) as a feedstock for biodiesel, it typically must first be purified through the removal of contaminates introduced into the cooking oil during its life (i.e., during use). In essence, the quality of the oil required for use in biodiesel is much higher than other uses. There are many ways to purify or refine used cooking oil into an acceptable product for biodiesel feedstock, however; the easiest of all is storing the used cooking oil in a heated tank and using gravity to force any contaminates therein to settle in the bottom of the heated tank. Typically, this process yields a bottom layer of solid contaminates, a middle layer of liquid contaminates such as water, and a top layer of the desired recycled or processed cooking oil (such as vegetable oil). The downsides to this process is it is time consuming and does only an adequate job at removing the impurities and separating the recycled or processed cooking oil.

The recycled or processed cooking oil produced by this process typically will then need to be filtered, sometimes several times down to under 200 micron before being usable, or at least used as valuable, biodiesel feedstock. Even the best attempts at this process can result in the solid contaminates removed from the used cooking oil containing almost 50% oil. As a result, much of the expensive and usable cooking oil is lost during this type of refinement process. Further, using this type of method requires a timely batch process procedure. A batch process procedure typically requires large and costly equipment and layout. Further, a typical batch process procedure can take upwards of 72 hours to complete.

Potentially because of these time consuming, large and inefficient processes, methods and apparatuses, only a small fraction of used cooking oil is used to produce biodiesel. For example, it has been reported that only 16% of the used cooking oil produced in the U.S. every year is converted into biodiesel. The remainder of the used cooking oil produced is either put into feed for animals, put into landfills or sent overseas and used as cooking oil in third world countries. No set method, system or apparatus exists for processing used cooking oil for use in biodiesel. Most existing processing systems and methods either use gravity separation or some sort of mechanical device, and are configured as batch systems and methods. Unlike these prior methods and systems, the methods, systems and apparatuses disclosed herein are automated and form an end-to-end non-batch process (i.e., continuous, at least for a predefined time period) that receives used cooking oil in one end and yields highly refined, quality recycled used cooking oil biodiesel feedstock output at the other end.

As an example, under some current systems it takes approximately 24-72 hours for a 3,000 gallon container of used cooking oil to settle via in the presence of heat. Operationally, these current systems need a holding tank, a settling tank and a finished product tank—assuming ideal timing between raw product coming in and finished product going out. Through the use of extrapolation, these current systems may be capable of yielding approximately 876,000 gallons of recycled or processed used cooking oil per year at an 80% uptime. In comparison, the exemplary methods, apparatus, systems and the like disclosed herein are capable of yielding approximately 4.2 million gallons of recycled or processed used cooking oil per year at a continuous flow rate of about 10 gallons per minute. Thereby, the exemplary methods, apparatus, systems and the like disclosed herein may be capable of providing over four times the amount of recycled or processed used cooking oil provided from current gravity systems utilizing a similar overall processing plant footprint.

As yet another example, the loss or fallout from the currently accepted standard gravity separation processes is approximately 20%. It is estimated that about 5% of this fallout is from the removal of solid contaminates and about 15% is from the removal of liquid contaminates, namely water. The removed solids from the current gravity processes typically contain approximately 50% pure cooking oil and the water or other liquid removed from these processes contain approximately 10% pure cooking oil. In comparison, the exemplary methods, apparatus, systems and the like disclosed herein are capable of separating solids containing less than 1% pure cooking oil and/or liquids (e.g., water) containing less than 1% pure cooking oil. Thereby, at a 1 MGY facility including the exemplary methods, apparatus, systems and the like disclosed herein 24,500 more gallons of recycled or processed used cooking oil product can be extracted from the solids alone as compared to current gravity systems.

As another example, the moisture, insolubles, and unsaponifiables (MIU) remaining in the recycled or processed cooking oil produced from current gravity separation processes can vary, but are typically in the 2% to 6% range. In comparison, initial tests of some of the exemplary methods, apparatus, systems and the like disclosed herein produced recycled or processed cooking oil that included 0.5% or less moisture, insolubles, and MIU contaminates. As is known in the art, a decrease of just 4% in MIU of recycled cooking oil can mean a corresponding increase in price of $0.02 per pound of product.

Accordingly, it is an object of the present inventions to overcome one or more of the above-described drawbacks and/or disadvantages of the prior art.

### SUMMARY OF THE INVENTION

The present disclosure is directed to exemplary apparatuses and methods disclosed herein may be effective in heating, separating and filtering used cooking oil with a very high degree of efficiency and in a timely manner to produce valuable and useful recycled, processed or refined cooking oil that can be used as feedstock for the production of biodiesel. The disclosed systems, apparatuses and methods have particular utility with used vegetable cooking oil and oil recovered from grease traps. As discussed above, current or typical used cooking oil refinement or processing separation is timely. For example, processing used cooking oil through heating and gravity methods alone may take a minimum of about 24 hours (typically at least about 72 hours), and is done through batch process methods. The disclosed system, methods and apparatuses take only a fraction of that time and result in a continuous processing rate of at least about 8 gallons per minute of high quality recycled cooking oil. Further, the separation yield resulting from the methods and apparatuses is more efficient. For example, in some embodiments the solid contaminates removed from the used cooking oil may contain less than 1% pure cooking oil, and the liquid contaminates, namely water, removed from the used cooking oil may contain less than 1% pure cooking oil. Still further, many components of the system, including controls, may be housed within a standard shipping, tractor trailer container or other like pre-defined area or structure, thereby ensuring a small footprint and making the system easily mobile.

For example, in accordance with one aspect of the present invention a method of processing used cooking oil to remove contaminates therefrom to produce recycled cooking oil is disclosed. In some embodiments, the method may comprise passing used cooking oil through a first filter to remove solid contaminates of a first size from the used cooking oil. In some such embodiments, the method may further comprise heating used cooking oil that passed through the first filter by a heating mechanism to at least about 120 degrees Fahrenheit. In some such embodiments, the method may further comprise transferring used cooking oil heated by the heating mechanism to a centrifuge mechanism. In some such embodiments, the centrifuge mechanism processes the used cooking oil to remove at least one of solid contaminates and liquid contaminates therefrom. In some such embodiments, the method may further comprise passing used cooking oil processed by the centrifuge mechanism through a second filter to remove solid contaminates of a second size that are smaller than the solid contaminates of the first size separated by the first filter to produce recycled cooking oil. In some such embodiments, the method may further comprise transferring recycled cooking oil output from the second filter into at least one storage tank. In some such embodiments, the at least one storage tank is capable of agitating and heating the recycled cooking oil therein to at least 120 degrees Fahrenheit. In some such embodiments, the method may be performed as a continuous process producing a continuous flow of the recycled cooking oil from the second filter.

In some embodiments, the method may produce a continuous flow of at least 8 gallons per minute of the recycled cooking oil for a predefined time period. In some such embodiments, the recycled cooking oil produced may contain at least one of less than about 1% liquid contaminates and less than about 1% solid contaminates. In some embodiments, the aggregate of at least the solid contaminates removed from used cooking oil by the first filter, centrifuge member and second filter during the method to produce the recycled cooking oil contains less than about 1% pure vegetable oil.

In some embodiments, the first filter is a dual filter comprising two filtering portions, and the dual filter is effective to selectively divert the used cooking oil flowing therethrough through only one of the two filtering portions at one time.

In some embodiments, the heating mechanism is a heat exchanger, and used cooking oil that passes through the first filter flows through the heat exchanger to heat the used cooking oil that flows to the centrifuge mechanism to a temperature within the range of about 120 degrees Fahrenheit to about 140 degrees Fahrenheit. In some such embodiments, the method further comprises diverting at least a portion of the used cooking oil passing through the first filter past the heating mechanism to regulate at least one of the pressure and temperature of the used cooking oil flowing to the centrifuge mechanism. Similarly, in some embodiments the heat exchanger and the at least one storage tank utilize steam at least in part to heat the used cooking oil and the recycled cooking oil therein, respectively. In some embodiments, a first boiler produces the steam for both the heat exchanger and the at least one storage tank.

In some embodiments, the method further comprises passing used cooking oil heated by the heating mechanism through a separator to separate solid contaminates from the used cooking oil passing therethrough, and passing the used cooking oil flowing through the separator to the centrifuge mechanism.

In some embodiments, the first filter is configured to remove solid contaminates that include at least one dimension larger than about 0.05 inch from the used cooking oil passing therethrough, and the second filter is configured to remove solid contaminates that include at least one dimension larger than about 0.005 inch from the used cooking oil passing therethrough.

In some embodiments, the centrifuge mechanism produces distinct flows of the solid contaminates, liquid contaminates and used cooking oil separated from the used cooking oil input therein, and the method further comprises transferring solid and liquid contaminates produced by the centrifuge mechanism into a storage tank.

In some embodiments, at least the first filter, the heating mechanism, the centrifuge mechanism and the second filter are housed within a defined area. In some embodiments, the defined area is a standard shipping container.

In some embodiments, the method further comprises passing used cooking oil passing through the first filter through an initial processing unit before passing it through the first filter. In some such embodiments, the initial processing unit comprises a third filter to remove solid contaminates of a third size that are larger than the solid contaminates of the first size separated by the first filter and a series of bellows to remove at least one of solid and liquid contaminates from the used cooking oil passing through the third filter.

In another example, in accordance with one aspect of the present invention a system for processing used cooking oil to remove contaminates therefrom is disclosed. In some such embodiments, the system comprises a first filter configured to remove solid contaminates of a first size from used cooking oil flowing therethrough. In some such embodiments, the system further comprises a heating mechanism in communication with the first filter to receive used cooking oil flowing therefrom, the heating mechanism configured to heat the used cooking oil flowing therethrough to at least about 120 degrees Fahrenheit. In some such embodiments, the system comprises a centrifuge mechanism in communication with the heating mechanism to receive heated used cooking oil therefrom, the centrifuge mechanism configured to process the used cooking oil to remove solid contaminates and liquid contaminates therefrom. In some such embodiments, the system comprises a second filter in communication with the centrifuge mechanism to receive used cooking oil flowing therefrom, the second filter configured to remove solid contaminates of a second size from the used cooking oil that are smaller than the solid contaminates of the first size separated by the first filter to produce processed recycled cooking oil. In some such embodiments, the system comprises at least one storage tank configured to store, agitate and heat recycled cooking oil therein to at least about 120 degrees Fahrenheit. In some such embodiments, the system is configured such that used cooking oil flows continuously through the system to produce a continuous flow of the recycled cooking oil from the second filter.

In some embodiments, the system produces a continuous flow of recycled cooking oil from the second filter of at least 8 gallons per minute for a predefined time period. In some such embodiments, the recycled cooking oil contains at least one of less than about 1% liquid contaminates and less than about 1% solid contaminates. In some such embodiments, the first filter is a dual filter comprising two filtering portions, and the dual filter is configured such that the used cooking oil flowing therethrough selectively flows through only one of the two filtering portions at one time.

In some embodiments, the heating mechanism is a heat exchanger, and the system is configured such that used cooking oil that passes through the first filter flows through the heat exchanger and is heated to a temperature within the range of about 120 degrees Fahrenheit to about 140 degrees Fahrenheit. In some such embodiments, the heat exchanger and the at least one storage tank utilize steam at least in part to heat the used cooking oil and the recycled cooking oil therein, respectively. In some such embodiments, the system further comprises a first boiler that supplies steam to both the heat exchanger and the at least one storage tank.

In some embodiments, the system further comprises a separator in communication with the heating mechanism and the centrifuge mechanism such that used cooking oil flowing from the heating mechanism flows through the separator and to the centrifuge mechanism. In some such embodiments, the separator separates at least solid contaminates from the used cooking oil flowing therethrough.

In some embodiments, the centrifuge mechanism produces distinct flows of the solid contaminates, liquid contaminates and used cooking oil separated from the used cooking oil input therein. In some such embodiments, the system further comprises at least one tank in communication with the centrifuge mechanism for storing solid and liquid contaminates separated by the centrifuge mechanism.

In some embodiments, at least the first filter, the heating mechanism, the centrifuge mechanism and the second filter are housed within a defined area. In some such embodiments, the defined area is a standard shipping container.

In some embodiments, the system further comprises an initial processing unit in communication with the first filter for supplying used cooing oil thereto, the initial processing unit comprising a third filter configured to remove solid contaminates of a third size that are larger than the solid contaminates of the first size separated by the first filter, and a series of bellows configured to remove at least one solid and liquid contaminate from used cooking oil passing through the third filter.

In some embodiments, the system further comprises at least one pump for pumping the used cooking oil, and thereby the recycled cooking oil, through the respective components of the system. In some embodiments, the system comprises at least one of a pressure valve and a temperature valve configured to divert at least a portion of used cooking oil passing through the first filter past the heating mechanism to regulate at least one of the pressure and temperature of the used cooking oil flowing to the centrifuge mechanism.

Other objects, aspects and advantages of the pottery holding devices of the present invention, and/or of the currently preferred embodiments thereof, will become more readily apparent in view of the following detailed description of the currently preferred embodiments and the accompanying drawings.

### BRIEF DESCRIPTION OF THE DRAWINGS

FIG. 1 is a schematic of a first exemplary embodiment of a used cooking oil processing apparatus, system and method;

FIG. 2 is a schematic of a portion of a second exemplary embodiment of a used cooking oil processing apparatus, system and method; and

FIG. 3 is a schematic of a portion of a third exemplary embodiment of a used cooking oil processing apparatus, system and method.

### DETAILED DESCRIPTION

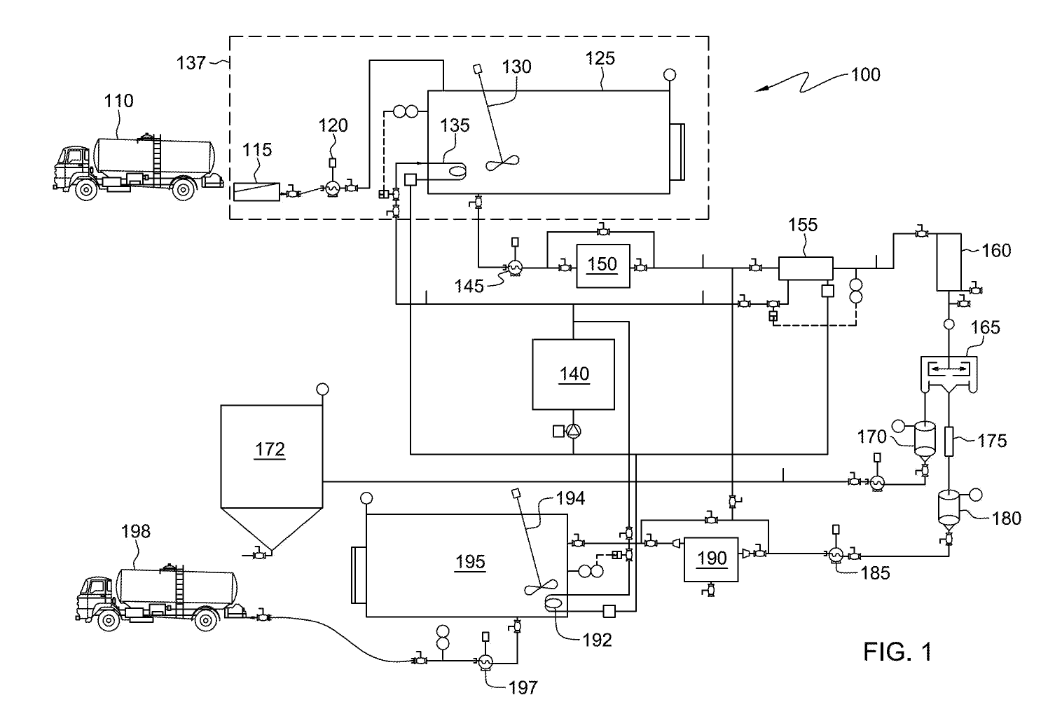

In FIG. 1, used cooking oil processing apparatuses, systems and methods embodying a first exemplary embodiment of the present invention is indicated generally by the reference numeral 100. As shown in FIG. 1, the exemplary system/method 100 may include a continuous serial process to heat, separate and filter the used cooking oil (herein “UCO”) in a much faster and efficient way resulting in a higher quality, more consistent feedstock than compared to traditional systems and methods, such as gravity based processing. Used cooking oil (UCO) may be any oil used or produced during cooking, such as vegetable oil and oil recovered from grease traps. In some embodiments, the UCO may be oil other than used cooling oil that has the same or similar material properties, functions, structure, use or the like as used cooking oil. In essence, the systems and methods disclosed herein process used cooking oil to remove contaminates therefrom to produce recycled cooking oil. For example, the exemplary system and method 100 of FIG. 1 may be effective in producing recycled cooking (herein “RCU”) at a minimum rate of eight gallons per minute. In some embodiments, the exemplary system and method may be effective in producing RCU at a minimum rate of 10 gallons per minute. Similarly, in some exemplary embodiments RCU may be produced at a minimum rate of 12 gallons per minute. Some exemplary embodiments may be effective in producing RCU at a minimum rate within the range of about 5 gallons per minute to about 100 gallons per minute, and more preferably about 8 gallons per minute to about 14 gallons per minute, and more preferably about 10 gallons per minute to about 14 gallons per minute, or about 10 gallons per minute to about 12 gallons per minute. As a result, some exemplary system and method embodiments have the capacity of processing at least approximately 4 million gallons per year of high quality RCO.

As another example of the effectiveness of the exemplary systems, apparatuses and methods 100 of FIG. 1, the input UCO collected or otherwise obtained may include about 10% to about 20% solid and liquid contaminates (i.e., any substances other than pure cooking oil), and the RCO output by the exemplary system and methods 100 may include between about 2% and about 7% total solid and liquid contaminates. Still further, the solid contaminates removed from the UCO during the system and methods may include less than about 5% pure cooking oil, and more preferably less than about 1% pure cooking oil. Similarly, the liquid contaminates, typically water, removed from the UCO during the system and methods may include less than about 5% pure cooking oil, and more preferably less than about 1% pure cooking oil. In some exemplary embodiments, RCO output by the exemplary systems and methods 100 may include less than about 0.5% total solid and liquid contaminates.

In use, UCO may be input in one end of the exemplary system/method 100 and recycled or processed cooking oil (RCO), such as vegetable oil, may be output at the other end. Stated differently, raw product (UCO) containing solid and liquid (e.g., moisture) contaminates are input into one end of the system/method 100 and finished product (RCO) substantially free of the solid and liquid contaminates comes output at the other end of the system/method pathway.

As shown in FIG. 1, UCO may be collected from external sources (e.g. restaurants) and delivered to the location of the system/method 100. In some embodiments, the collection of the UCO forms part of the system/method 100. In some embodiments, the UCO is delivered to the site and pumped from a truck or other storage vessel 110 through a first course filter 115, such as a screen, to remove solids (i.e., solid contaminates) that include at least one dimension lager than a first predefined size. For example, in some exemplary embodiments the first filter 115 may include a screen, mesh or any other known filtering medium, method, or arrangement configured such that solid contaminates that include at least one dimension larger than about ⅛ of an inch will be prevented from passing therethrough. In this way, the exemplary filter 115 may initially remove solid contaminated from the UCO to provide a first filtering, processing, refining or other step to, ultimately, produce high quality, usable RCO biodiesel feedstock. When the system/method 100 is not running, the exemplary first filter 115 may be cleaned or emptied such that the contaminates filtered from the UCO passing therethrough are removed. The removed solid contaminates from the first filter 115, for example, may be stored elsewhere and, eventually, sold for fertilizer or the like.

UCO passing through the exemplary first filter 1150 may flow into an initial storage tank 125, as shown in FIG. 1. For example, as shown in the illustrated embodiment UCO successfully passing through the first filter 115 may be pumped by a first pump 120 from the exemplary first filter 115 and into the exemplary initial storage tank 125. As also shown in FIG. 1, the exemplary initial storage tank 125 may include an exemplary agitating mechanism 130 for agitating the UCO stored within the initial storage tank 125, and/or an exemplary heating mechanism 135 to heat the UCO stored with the exemplary initial storage tank 125. In the illustrated exemplary embodiment 100 shown in FIG. 1, the exemplary initial storage tank 125 includes both an exemplary heating mechanism 135 and an exemplary agitating mechanism 130. The exemplary heating mechanism 135 and the exemplary agitating mechanism 130 may be any heating and agitating mechanism. For example, the exemplary heating mechanism 135 may be a heat exchanger utilizing steam, such as steam provided by a first boiler 140. In the illustrated exemplary embodiment, the exemplary heating mechanism 135 is a steam-based heat exchanger capable of heating the UCO stored therein to a temperature of at least about 120 degree Fahrenheit. As another example the exemplary agitating mechanism 130 may be a motorized paddle, blade, propeller or other like mechanism for agitating the UCO contained within the exemplary initial storage tank 125 to keep the UCO therein well mixed. The UCO may be kept well mixed so the UCO does not separate, for example. In some embodiments, the agitating mechanism 130 and the heating mechanism 135 may be effective to keep the UCO stored within the initial storage tank 125 both well mixed and heated so that is can be pumped therefrom and consistently processed thereafter. Once the UCO is contained within the initial storage tank 125, and potentially sufficiently heated by the heating mechanism 135 and agitated by the agitating mechanism 130, the UCO may then be pumped from the initial storage tank 125 by a second pump 145.

The exemplary initial storage tank 125 may also be configured as a separator. For example, the exemplary initial storage tank 125 may be configured such that it is effective in removing at least one of solid and liquid contaminates from the UCO flowing therethrough. For example, the initial storage tank 125 may be configured as an oil-water separator effective in removing both water and solid contaminates from the UCO. In one exemplary embodiment, the exemplary initial storage tank 125 may include one or more baffle or bellow of which the UCO passing through the exemplary initial storage tank 125 must pass over or under. In some embodiments, the initial storage tank 125 may include an inlet chamber behind a first baffle, where solids settle out and collect on the bottom of the chamber. In some embodiments, the exemplary initial storage tank 125 may include a second baffle (such as past the first baffle in the direction of the flow of UCO). The second baffle may be configured with a passageway above or below the second baffle. In such embodiments, the UCO may flow over the second baffle while water, for example, remains trapped behind the second baffle. Similarly, water, for example, may flow under the second baffle and UCO may be trapped behind the second baffle. In these ways, for example, liquids such as water may be separated from the UCO and collected from the exemplary initial storage tank 125. Other known configuration of separators, such as oil-water separators and non-oil-water separators, may likewise be used in the exemplary system/method 100.

In some embodiments, the exemplary first filter 115 and exemplary initial storage tank 125 may be combined. For example, the first filter 115 may be positioned above the initial storage tank 125 such that UCO passing through the first filter 115 falls via gravity into the initial storage tank 125. Similarly, as indicated in FIG. 1, the first filter 115 and initial storage tank 125 may be considered an initial processing step or unit 137, and may be performed separately from later steps/processes.

UCO from the exemplary first filter 115, exemplary initial storage tank 125 or both may then flow through an exemplary second filter 150, as illustrated in the exemplary illustrated embodiment in FIG. 1. The exemplary second filter 150 may be effective in filtering solid contaminated from the UCO passing therethrough that include at least one dimension larger than a second predefined size. In some embodiments, the exemplary second filter may be configured to remove solid contaminates that are larger, in some respect, than the solid contaminates removed by the exemplary first filter 115. For example, in some exemplary embodiments the second filter 150 may include a screen, mesh or any other known filtering medium, method, or arrangement configured such that solid contaminates that include at least one dimension larger than about 0.05 inch will be prevented from passing therethrough. For example, the second filter 150 may include a 10 mesh screen. In this way, the exemplary second filter 150 may further remove solid contaminates from the UCO to provide a second filtering, processing, refining or other step to, ultimately, produce high quality, usable RCO biodiesel feedstock.

As shown in FIG. 1, UCO flowing through the exemplary second filter 150 may be then directed to an exemplary heating mechanism 155 effective to heat the UCO. For example, the exemplary heating mechanism 155 may be capable of heating UCO passing therethrough to a temperature of at least about 120 degrees Fahrenheit. In some embodiments, the exemplary heating mechanism 155 may be configured to heat UCO passing therethrough within the range of about 120 degrees Fahrenheit to about 250 degrees Fahrenheit, and more preferably within the range of about 120 degrees Fahrenheit to about 160 degrees Fahrenheit, and more preferably within the range of about 120 degrees Fahrenheit to about 160 degrees Fahrenheit, and more preferably within the range of about 140 degrees Fahrenheit to about 160 degrees Fahrenheit.

In some embodiments, the exemplary heating mechanism 155 may be any heating mechanism capable of heating UCO to at least about 120 degrees Fahrenheit. For example, in the illustrated exemplary embodiment the heating mechanism 155 is a heat exchanger. In some such exemplary embodiments, the heating mechanism 155 may be a 250,000 btu/hr heat exchanger (other sized heaters or types of heaters may be used) powered by a steam boiler (or like device) and heated to approximately 160 degrees Fahrenheit to about 180 degrees Fahrenheit, although the range may be between 140 degrees Fahrenheit to about 250 degrees Fahrenheit. For example, the exemplary heating mechanism 155 may be a heat exchanger that utilizes steam provided by the first boiler 140.

After UCO is heated by the exemplary heating mechanism 155, it may be passed through an exemplary separator 160 to further remove solid contaminates from the UCO, as shown in FIG. 1. For example, in the illustrated exemplary embodiment UCO operably heated by the exemplary heating mechanism 155 is passed through an exemplary high velocity, centrifugal separator creating a vortex effect that separates remaining solids (e.g., grit or particles introduced during a cooking process). In some embodiments, the separator is a Lakos brand, model CSX separator. The solids collected by the exemplary separator 160 (and/or the second filter 150) may be removed therefrom and put into a separate container for additional processing.

UCO that has passed through the exemplary heating mechanism 155, and potentially the exemplary separator 160, may be passed through an exemplary centrifuge mechanism 165, as shown in FIG. 1. In some embodiments, the exemplary centrifuge mechanism 165 may be effective is removing both solid and liquid, such as water, contaminates from the UCO passing therethrough.

For example, in the illustrated embodiment the exemplary centrifuge mechanism 165 is a three-phase centrifuge system that is designed for removing both water and solids from UCO passing therethrough. In some such embodiments, the exemplary centrifuge mechanism 165 is an Alpha Laval brand, model MAPX210, centrifuge. The exemplary centrifuge mechanism 165 may include one or more bowls rotating at high speeds that replace the effect of gravity on solids and liquids of different mass by a controllable centrifugal force. To lubricate such bowls, for example, the exemplary centrifuge mechanism 165 may be in communication with the heating mechanism 155 and/or first boiler 140 to receive water as lubricant.

The controllable centrifugal force of the exemplary centrifuge mechanism 165 may correspond to thousands of times that of gravity, for example. When subject to such forces, the solid and liquid contaminates or particles—which are denser than oil—may be pressed outwards against the rotating bowl wall to different heights. As such, moisture and solid contaminates may be individually removed from the UCO. Stated differently, the exemplary centrifuge mechanism 165 may be effective is removing solid and liquid contaminates from the UCO passing therethrough in distinct flows or compartments. In the illustrated embodiment, as shown in FIG. 1, solid and liquid contaminates removed by the exemplary centrifuge mechanism 165 may be combined into an exemplary centrifuge storage tank 170. The contaminates that collect in the exemplary centrifuge storage tank 170 may be transferred (e.g., pumped) into one or more permanent and larger second centrifuge storage tank or tanks 172. In some embodiments, the solid contaminates removed from the UCO passing through the exemplary centrifuge mechanism 165 contain virtually no pure cooking oil content. By comparison, using the currently accepted settling process via gravity results in the removal of solids from UCO containing about 50% pure cooking oil. In addition to the significant efficiencies from an extraction stand point, the low oil content solids can make further innovative and valuable organic compost fertilizer.

UCO passing through (or past) the exemplary centrifuge mechanism 165 may pass through an exemplary sight glass 175 so that an operator can inspect the UCO product before it is placed in an exemplary hold-up tank 180, as shown in FIG. 1. The exemplary hold-up tank 180 may allow samples of the UCO to be tested for quality. From the exemplary hold-up tank 180, the UCO therein may then be pumped by an exemplary third pump 185 through an exemplary third filter 190.

The exemplary third filter 190 may be effective in filtering solid contaminates from the UCO passing therethrough that include at least one dimension larger than a third predefined size. In some embodiments, the exemplary third filter 190 may be configured to remove solid contaminates that are larger, in some respect, than the solid contaminates removed by the first filter 115 and the second filter 150. For example, in some exemplary embodiments the exemplary third filter 190 may include a screen, mesh or any other known filtering medium, method, or arrangement configured such that solid contaminates that include at least one dimension larger than about 0.005 inch will be prevented from passing therethrough. For example, the exemplary third filter 190 may include one or more 100 micron bad filters. In this way, the exemplary third filter 190 may remove further solid contaminates from the UCO to provide an exemplary third filtering, processing, refining or other step to, ultimately, produce high quality, usable RCO biodiesel feedstock. In fact, in some embodiments the cooking oil passing through the exemplary third filter 190 may be considered RCO (because of its quality (level of contaminates), for example).

The RCO produced by the exemplary third filter 190, at least in part, may be transferred into an exemplary RCO holding tank 195. Like with the exemplary illustrated initial storage tank 125, the exemplary RCO holding tank 195 may include an exemplary agitating mechanism 194 for agitating the RCO stored within the holding tank 195, and/or an exemplary heating mechanism 192 to heat the RCO stored with the exemplary holding tank 195. In the illustrated exemplary embodiment 100 shown in FIG. 1, the exemplary holding tank 195 includes both an exemplary heating mechanism 192 and an exemplary agitating mechanism 194. The exemplary heating mechanism 194 and the exemplary agitating mechanism 192 may be any heating and agitating mechanism. For example, the exemplary heating mechanism 192 may be a heat exchanger utilizing steam, such as steam provided by a first boiler 140. In the illustrated exemplary embodiment, the exemplary heating mechanism 192 is a steam-based heat exchanger capable of heating the UCO stored therein to a temperature of at least about 120 degree Fahrenheit. As another example, the exemplary agitating mechanism 194 may be a motorized paddle, blade, propeller or other like mechanism for agitating the RCO contained within the exemplary holding tank 195 to keep the RCO well mixed. The RCO may be kept well mixed so the RCO does not separate, for example. In some embodiments, the exemplary agitating mechanism 194 and the exemplary heating mechanism 192 may be operably effective to keep the RCO stored within the exemplary holding tank 195 both well mixed and heated so that is can be pumped therefrom, is consistent (i.e., well mixed), and meets other industry feedstock “buyer” standards.

As also shown in FIG. 1, RCO contained within the exemplary holding tank 195, and potentially sufficiently heated by the exemplary heating mechanism 192 and agitated by the exemplary agitating mechanism 194, may then be pumped by an exemplary fourth pump 197 into an exemplary mobile tank 198. The exemplary mobile tank 198 may be any tank capable of being transported, such as by a tractor trailer, rail car, or other vehicle or mechanism.

In some exemplary embodiments (not shown), one or more exemplary port may be provided directly up-stream of the exemplary separator 160 or exemplary centrifuge mechanism 165. The at least one port may allow for the addition of sodium hydroxide or NaOH or other similar compound. This may allow for the removal of fee fatty acid (FFA) in the product. NaOH may combine with triglyceride in the UCO to produce a soap. In some such embodiments, the FFA and soaps may be removed by the centrifuge mechanism 165 (in either of the solid or liquid contaminate flows). The FFA and soap removal process is typically referred to as caustic stripping.

As illustrated in FIG. 1, the s exemplary system/method 100 may include any number of pumps, valves, pipes, tubes, hoses, gauges, connections, sight glasses, and the like to transport the UCO/RCO through the exemplary system/method 100. For example, in some embodiments the exemplary system/method 100 may include 1 inch schedule 40 steel pipe extending from, or extending to, one or more components.

At least some of the components of the exemplary system/method 100 described herein with reference to FIG. 1 may be housed within an exemplary defined area. As such, the components housed within the defined area may be mobile. For example, in one embodiment at least the exemplary second filter 150, exemplary heating mechanism 155, exemplary centrifuge mechanism 175 and exemplary third filter 190 are included in the exemplary system/method 100 and housed within a defined area. In one such embodiment, the defined area may be a high-cube, forty foot shipping container, tractor trailer container or other standard mobile container. In some embodiments, the exemplary separator 160 is also included within the exemplary defined area.

In embodiments wherein components of the exemplary system/method 100 are housed within a exemplary defined area, such as an enclosed space equivalent to a 40′×8′ shipping container, the storage footprint of the exemplary system/method 100 is greatly reduced and the exemplary system/method 100 can be easily transported from site to site. As compared to previous systems/methods. As another example, any equipment, controls, wiring and piping may be entirely located within the shipping container or other defined area. In some embodiments, modifications may be made to the container for both personal and equipment access. For example, roller doors may be placed on the end or ends of the container and doorways may be on the sides of the container. Similarly, as another example, cut through connections in the defined area (e.g., container) may be provided for incoming raw product, outgoing finished product, incoming product treatment, outgoing co-products, electrical connections, and steam/power connections. The exemplary defined area (e.g., shipping container) may include its own lighting, heating, venting, and electrical connections. For example, three-phase power may be supplied for the operation of the some of the equipment or components. As the exemplary defined area may be mobile, the defined may be transported via a standard tractor trailer and placed on-site using a roll-off trailer or a high crane, for example.

The RCO produced by the exemplary system/method 100 may have an extremely low moisture content, an extremely low solids content, and a lower FFA content compared to prior systems/methods. Moisture content, solid content and FFA content are all qualities required by biodiesel refineries for its feedstock. Advantages of the disclosed exemplary systems/methods 100 over the typical standard gravity separation processes include the speed and efficiency at which the product is processed, the increased control over the resulting product quality, and the increased value of the co-products coming from the systems/methods/apparatuses.

For example, in one embodiment the exemplary system/method 100 may produce a continuous flow of RCO at a continuous flow rate of 10 gallons per minute. As such, the exemplary system/method 100 may produce 4.2 million gallons of RCO per year. Also, the solid contaminates removed during the exemplary system/method 100 may contain less than 1% cooking oil. Similarly, the liquid contaminates (namely water) removed during the exemplary system/method 100 may contain less than 1% cooking oil. Still further, the exemplary system/method 100 may produce a continuous flow of RCO that includes about 7% or less total contaminates (i.e., the aggregate of solid and liquid contaminates, and more preferably less than about 1% contaminates, and more preferably less than about 0.5% total contaminates. In some embodiments, the exemplary system/method 100 may produce a continuous flow of RCO that preferably includes between about 2% and 7% total contaminates. In some embodiments, the exemplary system/method 100 may produce RCO with less than about 1% liquid contaminates and less than about 1% solid contaminates.

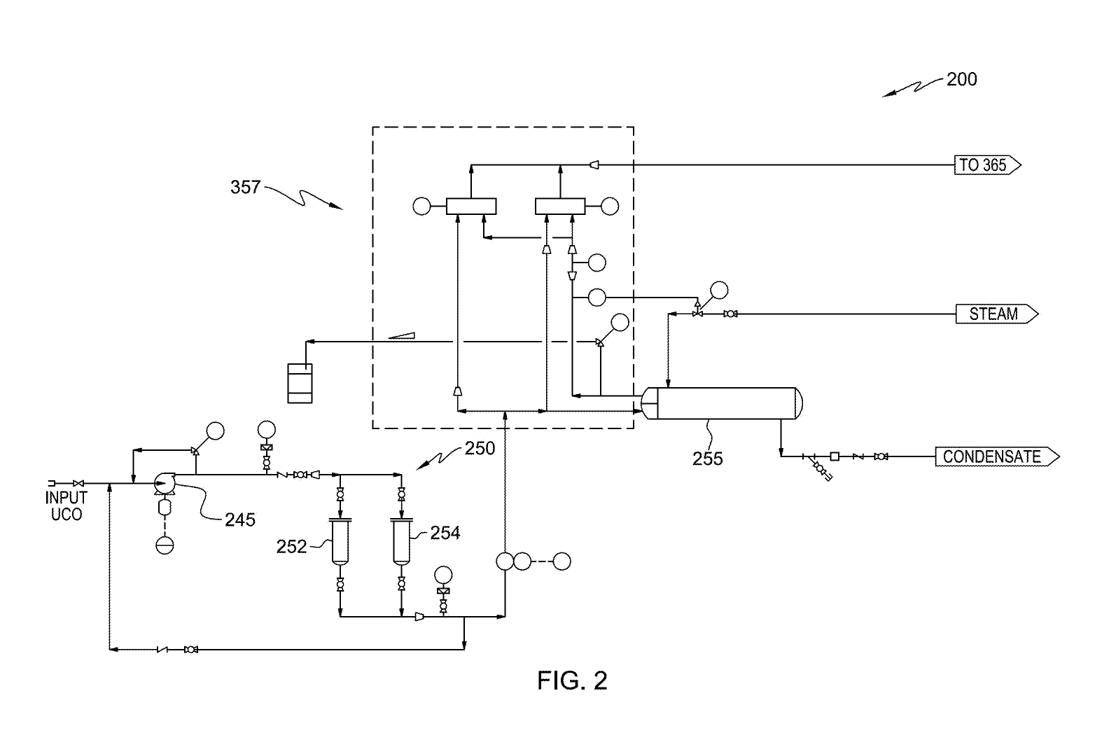

In FIG. 2, a portion of an exemplary UCO/RCO processing system/method of a second embodiment of the present invention is indicated generally by the reference numeral 200. The exemplary UCO/RCO processing system/method portion 200 is similar to the corresponding portion of the UCO/RCO processing system/method 100 described above with respect to FIG. 1. Therefore, like reference numerals preceded by the numeral “2,” as opposed to “1,” are used to indicate like elements. As shown in FIG. 2, the exemplary UCO/RCO processing system/method portion 200 differs from the corresponding portion of the exemplary UCO/RCO processing system/method 100 with respect to the configuration of the first filter 250.

As illustrated in FIG. 2, in some embodiments the exemplary second filter 250 may be configured such that it includes two distinct filtering passageways, such as including two distinct filtering portions. Further, the exemplary second filter 250 may be configured such that it may be selectively operated to direct the UCO passing through the first filter 250 through only one of the two filtering portions. In this way, the second filter 250 may be operative to allow one of the two filtering portions to be cleaned (such as removing the solid contaminates filtered out of the UCO thereby) without interrupting the process/method. The exemplary first filter 250 may otherwise be configured to allow cleaning during operation.

Another different between exemplary UCO/RCO processing system/method portion 200 and the corresponding portion of the exemplary UCO/RCO processing system/method 100 is the inclusion of control system 357 configured to regulate the temperature and pressure of RCO traveling directly to the centrifuge mechanism (not shown) or the separator (not shown). For example, the exemplary control system 357 includes a series of pipes and valves (and potentially gauges) configured to allow some of the RCO passing through the exemplary second filter 250 to be diverted past the exemplary heating mechanism 255, depending upon the temperature and pressure of the RCO. For example, the exemplary control system 357 may utilize one or more valves to ensure the RCO entering the exemplary centrifuge mechanism (not shown) or the separator (not shown), or simply leaving the heat exchanger 255, is about 140 degrees Fahrenheit or below and at a pressure of about 140 psi or below.

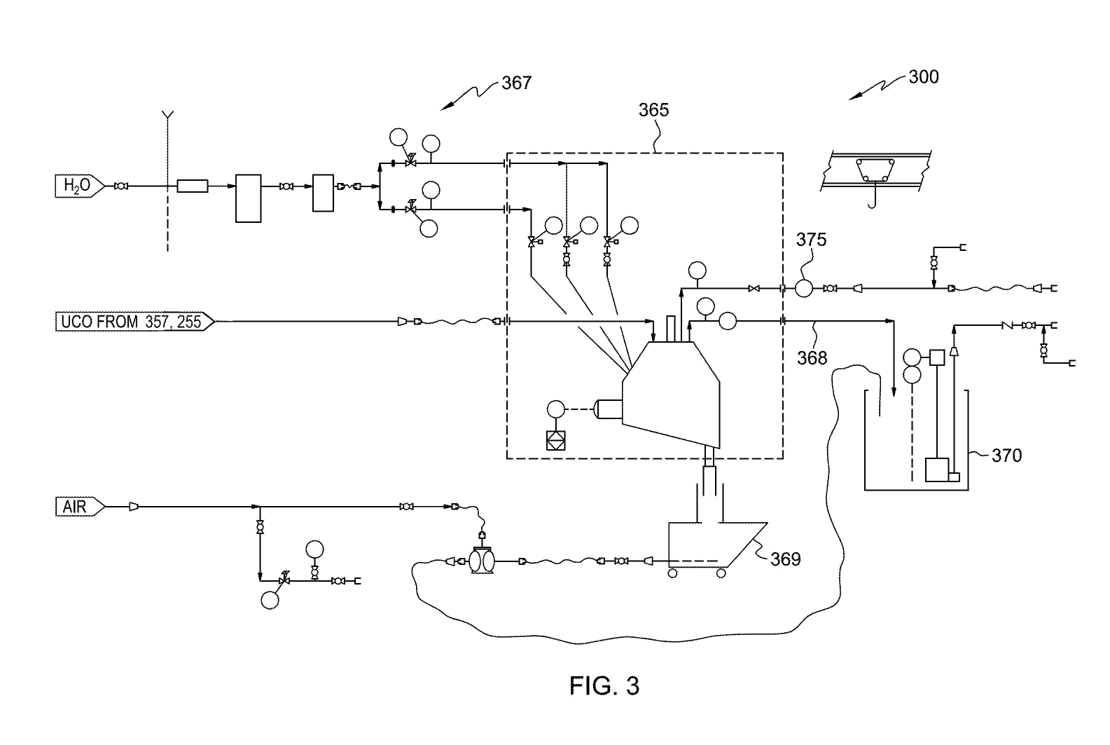

In FIG. 3, a portion of an exemplary UCO/RCO processing system/method of a second embodiment of the present invention is indicated generally by the reference numeral 300. The exemplary UCO/RCO processing system/method portion 300 is similar to the corresponding portion of the UCO/RCO processing system/method 100 described above with respect to FIG. 1. Therefore, like reference numerals preceded by the numeral “3,” as opposed to “1,” are used to indicate like elements. Further, it is noted that exemplary UCO/RCO processing system/method portion 300 is particularly compatible to cooperate with exemplary UCO/RCO processing system/method portion 200 of FIG. 2 described above to form partial or complete UCO-RCO processing systems/methods. As shown in FIG. 3, the exemplary UCO/RCO processing system/method portion 300 differs from the corresponding portion of the exemplary UCO/RCO processing system/method 100 with respect to the configuration of the output of the exemplary centrifuge mechanism 365.

As shown in FIG. 3, the exemplary centrifuge mechanism 365 of the UCO/RCO processing system/method portion 300 may include a series of exemplary valves and exemplary piping effective in regulating the temperature and/or pressure of the lubricating water entering the centrifuge mechanism 365, such as providing three separate flows to the exemplary centrifuge mechanism 365. Further, the exemplary centrifuge mechanism 365 may output the solid contaminates separated by from the UCO into an exemplary hopper 369, which then may be pumped into the exemplary centrifuge storage tank 170. Similarly, the liquid contaminates separated from the UCO by the exemplary centrifuge mechanism 365 may flow separately into the exemplary centrifuge storage tank 170 by exemplary piping 368.

As may be recognized by those of ordinary skill in the pertinent art based on the teachings herein, numerous changes and modifications may be made to the above-described and other embodiments of the present invention without departing from the spirit of the invention as defined in the claims. For example, components may be made of any of numerous different materials that are currently or later become known for performing any the functions of such components. In addition, not all elements or all features disclosed herein are necessary, and if desired, additional elements or features may be added. Further, components, aspects or combinations thereof described with a particular embodiment may be incorporated in another described embodiment to achieve the same or similar function as it achieved in the particular embodiment. Similarly, components may take any of numerous different shapes and/or configurations.

Accordingly, this detailed description of the illustrated and exemplary embodiments of the present invention is to be taken in an illustrative, as opposed to a limiting sense.

What is claimed is:

1. A method of processing used cooking oil to remove contaminates therefrom to produce recycled cooking oil, the method comprising:
passing used cooking oil through a first filter to remove solid contaminates of a first size from the used cooking oil;
heating used cooking oil that passed through the first filter by a heating mechanism to at least about 120 degrees Fahrenheit;
transferring used cooking oil heated by the heating mechanism to a centrifuge mechanism, wherein the centrifuge mechanism processes the used cooking oil to remove at least one of solid contaminates and liquid contaminates therefrom;
passing used cooking oil processed by the centrifuge mechanism through a second filter to remove solid contaminates of a second size that are smaller than the solid contaminates of the first size separated by the first filter to produce recycled cooking oil; and
transferring recycled cooking oil output by the second filter into at least one storage tank, wherein the at least one storage tank is capable of agitating and heating the recycled cooking oil therein to at least about 120 degrees Fahrenheit; and
wherein the method is performed as a continuous process producing a continuous flow of the recycled cooking oil from the second filter.

2. The method of claim 1, wherein the method produces a continuous flow of at least 8 gallons per minute of the recycled cooking oil for a predefined time period, and wherein the recycled cooking oil contains at least one of less than about 1% liquid contaminates and less than about 1% solid contaminates.

3. The method of claim 1, wherein the aggregate of at least the solid contaminates removed from used cooking oil by the first filter, centrifuge member and second filter during the method to produce the recycled cooking oil contains less than about 1% pure vegetable oil.

4. The method of claim 1, wherein the first filter is a dual filter comprising two filtering portions, and wherein the dual filter is effective to selectively divert the used cooking oil flowing therethrough through only one of the two filtering portions at one time.

5. The method of claim 1, wherein the heating mechanism is a heat exchanger, and wherein used cooking oil that passes through the first filter flows through the heat exchanger to heat the used cooking oil that flows to the centrifuge mechanism to a temperature within the range of about 120 degrees Fahrenheit to about 140 degrees Fahrenheit.

6. The method of claim 5, wherein the method further comprises diverting at least a portion of the used cooking oil passing through the first filter past the heating mechanism to regulate at least one of the pressure and temperature of the used cooking oil flowing to the centrifuge mechanism.

7. The method claim of claim 5, wherein the heat exchanger and the at least one storage tank utilize steam at least in part to heat the used cooking oil and the recycled cooking oil therein, respectively, and wherein a first boiler produces the steam for both the heat exchanger and the at least one storage tank.

8. The method of claim 1, wherein the method further comprises passing used cooking oil heated by the heating mechanism through a separator to separate solid contaminates from the used cooking oil passing therethrough, and passing the used cooking oil flowing through the separator to the centrifuge mechanism.

9. The method of claim 1, wherein the first filter is configured to remove solid contaminates that include at least one dimension larger than about 0.05 inch from the used cooking oil passing therethrough, and wherein the second filter is configured to remove solid contaminates that include at least one dimension larger than about 0.005 inch from the used cooking oil passing therethrough.

10. The method of claim 1, wherein the centrifuge mechanism produces distinct flows of the solid contaminates, liquid contaminates and used cooking oil separated from the used cooking oil input therein, and wherein the method further comprises transferring solid and liquid contaminates produced by the centrifuge mechanism into a storage tank.

11. The method of claim 1, wherein at least the first filter, the heating mechanism, the centrifuge mechanism and the second filter are housed within a defined area.

12. The method of claim 11, wherein the defined area is a standard shipping container.

13. The method of claim 1, wherein the method further comprises passing used cooking oil passing through the first filter through an initial processing unit before passing it through the first filter, and wherein the initial processing unit comprises a third filter to remove solid contaminates of a third size that are larger than the solid contaminates of the first size separated by the first filter and a series of bellows to remove at least one of solid and liquid contaminates from the used cooking oil passing through the third filter.

14. A system for processing used cooking oil to remove contaminates therefrom, the system comprising:
a first filter configured to remove solid contaminates of a first size from used cooking oil flowing therethrough;
a heating mechanism in communication with the first filter to receive used cooking oil flowing therefrom, the heating mechanism configured to heat the used cooking oil flowing therethrough to at least about 120 degrees Fahrenheit;
a centrifuge mechanism in communication with the heating mechanism to receive heated used cooking oil therefrom, the centrifuge mechanism configured to process the used cooking oil to remove solid contaminates and liquid contaminates therefrom;
a second filter in communication with the centrifuge mechanism to receive used cooking oil flowing therefrom, the second filter configured to remove solid contaminates of a second size from the used cooking oil that are smaller than the solid contaminates of the first size separated by the first filter to produce processed recycled cooking oil; and
at least one storage tank configured to store, agitate and heat recycled cooking oil therein to at least about 120 degrees Fahrenheit; and
wherein the system is configured such that used cooking oil flows continuously through the system to produce a continuous flow of the recycled cooking oil from the second filter.

15. The system of claim 14, wherein the system produces a continuous flow of recycled cooking oil from the second filter of at least 8 gallons per minute for a predefined time period, and wherein the recycled cooking oil contains at least one of less than about 1% liquid contaminates and less than about 1% solid contaminates.

16. The system of claim 14, wherein the first filter is a dual filter comprising two filtering portions, and wherein the dual filter is configured such that the used cooking oil flowing therethrough selectively flows through only one of the two filtering portions at one time.

17. The system of claim 14, wherein the heating mechanism is a heat exchanger, and wherein the system is configured such that used cooking oil that passes through the first filter flows through the heat exchanger and is heated to a temperature within the range of about 120 degrees Fahrenheit to about 140 degrees Fahrenheit.

18. The system claim of claim 17, wherein the heat exchanger and the at least one storage tank utilize steam at least in part to heat the used cooking oil and the recycled cooking oil therein, respectively, and wherein the system further comprises a first boiler that supplies steam to both the heat exchanger and the at least one storage tank.

19. The system of claim 14, wherein the system further comprises a separator in communication with the heating mechanism and the centrifuge mechanism such that used cooking oil flowing from the heating mechanism flows through the separator and to the centrifuge mechanism, and wherein the separator separates at least solid contaminates from the used cooking oil flowing therethrough.

20. The system of claim 14, wherein the centrifuge mechanism produces distinct flows of the solid contaminates, liquid contaminates and used cooking oil separated from the used cooking oil input therein, and wherein the system comprises at least one tank in communication with the centrifuge mechanism for storing solid and liquid contaminates separated by the centrifuge mechanism.

21. The system of claim 14, wherein at least the first filter, the heating mechanism, the centrifuge mechanism and the second filter are housed within a defined area.

22. The system of claim 21, wherein the defined area is a standard shipping container.

23. The system of claim 14, wherein the system further comprises an initial processing unit in communication with the first filter for supplying used cooing oil thereto, the initial processing unit comprising a third filter configured to remove solid contaminates of a third size that are larger than the solid contaminates of the first size separated by the first filter, and a series of bellows configured to remove at least one solid and liquid contaminate from used cooking oil passing through the third filter.

24. The system of claim 14, wherein the system further comprises at least one pump for pumping the used cooking oil, and thereby the recycled cooking oil, through the respective components of the system.

25. The system of claim 14, wherein the system comprises at least one of a pressure valve and a temperature valve configured to divert at least a portion of used cooking oil passing through the first filter past the heating mechanism to regulate at least one of the pressure and temperature of the used cooking oil flowing to the centrifuge mechanism.
